(19) United States
(12) Patent Application Publication
(10) Pub. No.: US 2022/0187823 A1
(43) Pub. Date: Jun. 16, 2022

(54) METHODS AND SYSTEMS FOR DYNAMIC GEOFENCING

(71) Applicant: Caterpillar Inc., Peoria, IL (US)

(72) Inventors: Vijayakumar Ramasamy, Peoria, IL (US); Micheal D. Valerio, Peoria, IL (US); Matthew Fike, Peoria, IL (US)

(21) Appl. No.: 17/123,035

(22) Filed: Dec. 15, 2020

(51) Int. Cl. G05D 1/00; G05B 15/02; B60W 30/09

(52) U.S. Cl. CPC G05D 1/0011; G05B 15/02; B60W 2554/4041; B60W 30/09; G05D 1/0088

(57) ABSTRACT

A technique is directed to methods and systems of a dynamic geofence in a worksite environment. In some cases, cameras and sensors are placed on the machines to monitor the worksite and automatically create a geofence around a machine as it operates. The geofence can dynamically change as the machine navigates in the worksite. Machine operators or site personnel can receive an alert regarding the proximity of people or objects to the geofence around the machine. In some implementations, the machines are autonomous, semi-autonomous, or remote controlled from a modular and customized virtual cab. A remote-controlled machine can provide full machine maneuverability with the user at a safe distance from potentially hazardous environments. In some cases, the geofence is automatically created to cover the work area based on the semi-autonomous command assigned to the machine.

### BACKGROUND

Users may operate machinery in worksite environments. However, potentially dangerous conditions can exist when the operator is unaware of personnel, objects, or other machinery in the worksite. Safety for worksite personnel is a growing concern in the industry, and companies have implemented geofences in worksites to alert machinery operators of worksite boundaries. For example, U.S. Pat. No. 10,621,982B2 describes a method of mobile construction machines detecting speech processing triggers. In particular, the speech processing data is converted into control signals which operate the construction machine. For example, the operator says a speech command to receive an alert whenever the construction machine is approaching a geofence boundary. However, this method is only directed to alerting the operator when the machine has approached a static geofence.

### BRIEF DESCRIPTION OF THE DRAWINGS

FIG. 1 is a block diagram illustrating an overview of devices on which some implementations can operate.

FIG. 2 is a block diagram illustrating an overview of an environment in which some implementations can operate.

FIG. 3 is a block diagram illustrating components which, in some implementations, can be used in a system employing the disclosed technology.

FIG. 4 is a flow diagram illustrating a process used in some implementations for a dynamic geofence.

FIG. 5 is a flow diagram illustrating a process used in some implementations for operating a machine in a dynamic geofence.

FIG. 6 is a conceptual diagram illustrating an example of a worksite environment with a dynamic geofence.

FIG. 7 is a conceptual diagram illustrating an example of a worksite environment with a dynamic geofence displayed on a device.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to methods and systems of a dynamic geofence in a worksite environment. In some implementations, sensing devices (e.g., 3D cameras, sensors, satellites, drones, infrared cameras, range finders, geolocation monitors, motion sensors, temperature sensors, vibration, or tilt sensors etc.) monitor a worksite environment from positions inside or outside the worksite. A “worksite” as used herein refers to a location where work takes place. Examples of a worksite are, but not limited to, building construction site, road or bridge construction site, mining site, a factory floor, shipping and receiving docks, oil fields, or a pipeline site.

In a preferred embodiment, a network of sensing devices is placed at a perimeter of the worksite, or with a view of the worksite, to track individual objects (e.g., machines or persons). The network of devices creates a geofence (e.g., a virtual perimeter) around areas of the worksite or around individual machines. For example, the sensing devices are placed along the fence line of a worksite (or at locations throughout the worksite) to form a network to create a geofence to monitor machines operating (e.g., loading, dozing, excavating, leveling, digging, etc.) in the worksite. In a preferred embodiment, the geofence dynamically changes as the machine navigates locations in the worksite. For example, the geofence, using the machine as the origin point, dynamically adjusts to maintain a threshold distance around the machine, as the machine moves. In some cases, the geofence extends beyond the perimeter of the worksite. For example, the geofence monitors roads leading up to the perimeter to detect machines exiting or entering the worksite.

In some implementations, the network of sensing devices is placed on the machine itself to create a geofence around the machine. For example, the machine has its own geofence while operating in the worksite. The sensing devices on the machine can integrate with the sensing devices throughout the worksite to create geofences in the worksite or around other machines. In some embodiments, machine operators or site personnel receive an alert (e.g., sound-alert or flashing color icons) regarding the proximity of an obstacle (e.g., person, machine, or object) to the geofence around a machine. The machine operators or site personnel can receive the alert via a notification on a mobile device, lights or sound system at the worksite, or a safety meeting.

In some implementations, the machines are autonomous, semi-autonomous, or remote controlled from a modular and customized virtual cab. A remote control can provide full machine maneuverability to the operator from a safe distance (e.g., feet or miles away from a hazard), while the machine operates in hazardous environments. A single user can control multiple machines, simultaneously or one at a time, or virtually change jobsite locations without traveling from the office to the machine. The virtual cab can provide an experience to the operator with machine controls and displays similar to those inside an operator's cab of a machine. In some cases, the geofence is generated to cover the work area based on the semi-autonomous command assigned to the machine. The operator or other site personal can receive a live video feed of the jobsite and all safety alerts if objects or personnel intrude or come within a proximity of the geofence around the machine.

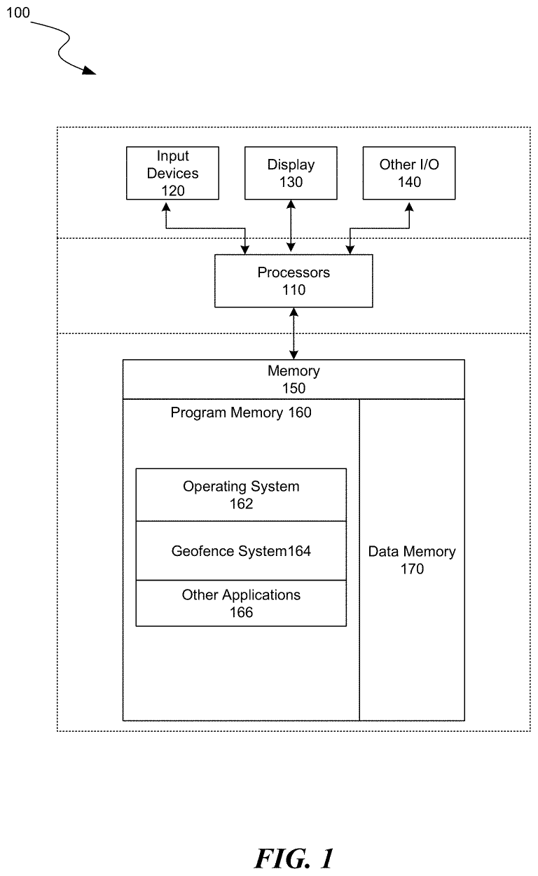

Several implementations are discussed below in more detail in reference to the figures. FIG. 1 is a block diagram illustrating an overview of devices on which some implementations of the disclosed technology can operate. The devices can comprise hardware components of a device 100 that manage entitlements within a real-time telemetry system. Device 100 can include one or more input devices 120 that provide input to the Processor(s) 110 (e.g. CPU(s), GPU(s), HPU(s), etc.), notifying it of actions. The actions can be mediated by a hardware controller that interprets the signals received from the input device and communicates the information to the processors 110 using a communication protocol. Input devices 120 include, for example, a mouse, a keyboard, a touchscreen, an infrared sensor, a touchpad, a wearable input device, a camera- or image-based input device, a microphone, or other user input devices.

Processors 110 can be a single processing unit or multiple processing units in a device or distributed across multiple devices. Processors 110 can be coupled to other hardware devices, for example, with the use of a bus, such as a PCI bus or SCSI bus. The processors 110 can communicate with a hardware controller for devices, such as for a display 130. Display 130 can be used to display text and graphics. In some implementations, display 130 provides graphical and textual visual feedback to a user. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network card, video card, audio card, USB, firewire or other external device, camera, printer, speakers, CD-ROM drive, DVD drive, disk drive, or Blu-Ray device.

In some implementations, the device 100 also includes a communication device capable of communicating wirelessly or wire-based with a network node. The communication device can communicate with another device or a server through a network using, for example, TCP/IP protocols. Device 100 can utilize the communication device to distribute operations across multiple network devices.

The processors 110 can have access to a memory 150 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, geofence system 164, and other application programs 166. Memory 150 can also include data memory 170, entitlement data, user data, retrieval data, management data, authorization token data, configuration data, settings, user options or preferences, etc., which can be provided to the program memory 160 or any element of the device 100.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

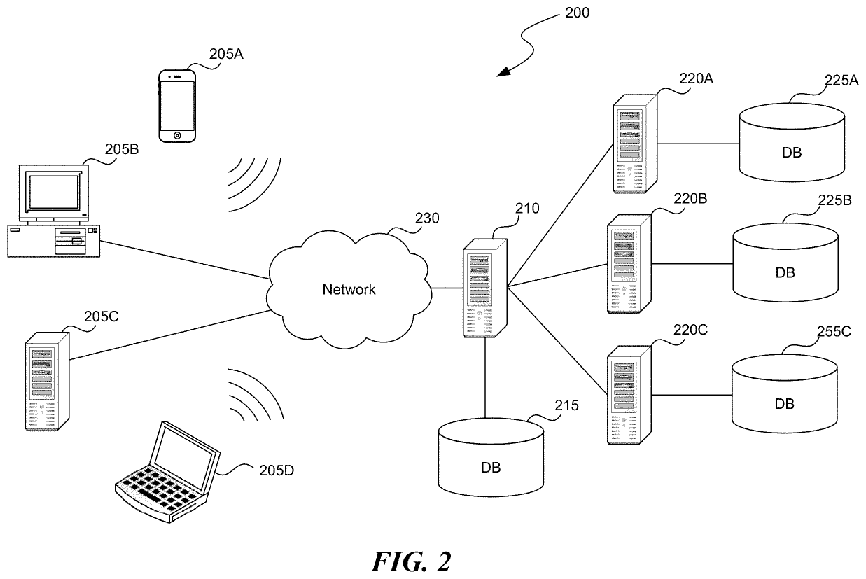

FIG. 2 is a block diagram illustrating an overview of an environment 200 in which some implementations of the disclosed technology can operate. Environment 200 can include one or more client computing devices 205A-D, examples of which can include device 100. Client computing devices 205 can operate in a networked environment using logical connections through network 230 to one or more remote computers, such as a server computing device.

In some implementations, server 210 can be an edge server which receives client requests and coordinates fulfillment of those requests through other servers, such as servers 220A-C. Server computing devices 210 and 220 can comprise computing systems, such as device 100. Though each server computing device 210 and 220 is displayed logically as a single server, server computing devices can each be a distributed computing environment encompassing multiple computing devices located at the same or at geographically disparate physical locations. In some implementations, each server 220 corresponds to a group of servers.

Client computing devices 205 and server computing devices 210 and 220 can each act as a server or client to other server/client devices. Server 210 can connect to a database 215. Servers 220A-C can each connect to a corresponding database 225A-C. As discussed above, each server 220 can correspond to a group of servers, and each of these servers can share a database or can have their own database. Databases 215 and 225 can warehouse (e.g. store) information such as geofence data, user data, machine data, sensor data, video data, and alert data. Though databases 215 and 225 are displayed logically as single units, databases 215 and 225 can each be a distributed computing environment encompassing multiple computing devices, can be located within their corresponding server, or can be located at the same or at geographically disparate physical locations.

Network 230 can be a local area network (LAN) or a wide area network (WAN), but can also be other wired or wireless networks. Network 230 may be the Internet or some other public or private network. Client computing devices 205 can be connected to network 230 through a network interface, such as by wired or wireless communication. While the connections between server 210 and servers 220 are shown as separate connections, these connections can be any kind of local, wide area, wired, or wireless network, including network 230 or a separate public or private network.

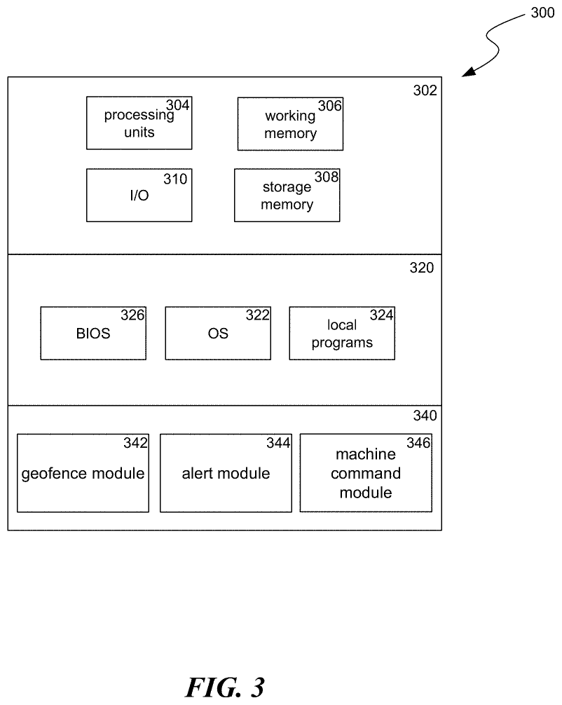

FIG. 3 is a block diagram illustrating geofence manager 300 which, in some implementations, can be used in a geofence management system employing the disclosed technology. The geofence manager 300 include hardware 302, general software 320, and specialized components 340. As discussed above, a system implementing the disclosed technology can use various hardware including processing units 304 (e.g. CPUs, GPUs, APUs, etc.), working memory 306, storage memory 308 (local storage or as an interface to remote storage, such as storage 215 or 225), and input and output devices 310. In various implementations, storage memory 308 can be one or more of: local devices, interfaces to remote storage devices, or combinations thereof. For example, storage memory 308 can be a set of one or more hard drives (e.g. a redundant array of independent disks (RAID)) accessible through a system bus or can be a cloud storage provider or other network storage accessible via one or more communications networks (e.g. a network accessible storage (NAS) device, such as storage 215 or storage provided through another server 220). geofence manager 300 can be implemented in a client computing device such as client computing devices 205 or on a server computing device, such as server computing device 210 or 220. Geofence manager 300 can connect to a wide area network (WAN) to communicate with individual machines, and/or is encompassed within the machine itself.

General software 320 can include various applications including an operating system 322, local programs 324, and a basic input output system (BIOS) 326. Specialized components 340 can be subcomponents of a general software application 320, such as local programs 324. Specialized components 340 can include geofence module 342, alert module 344, machine command module 346, and components which can be used for providing user interfaces, transferring data, and controlling the specialized components, such as interfaces for communications and sensor-specific functions. In some implementations, geofence manager 300 can be in a computing system that is distributed across multiple computing devices or can be an interface to a server-based application executing one or more of specialized components 340. Although depicted as separate components, specialized components 340 may be logical or other nonphysical differentiations of functions and/or may be submodules or code-blocks of one or more applications.

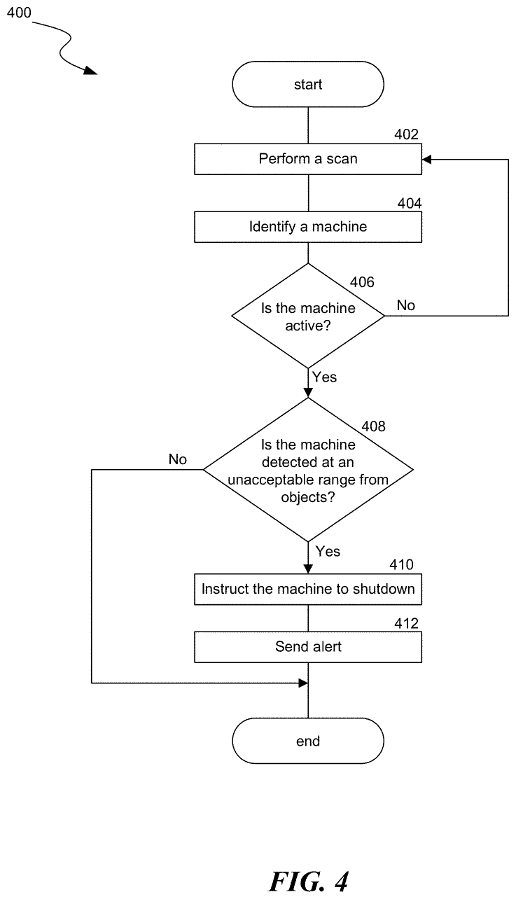

In some embodiments, the geofence module 342 is configured to generate a geofence (e.g., a virtual perimeter) around a machine or location at a worksite using a network of sensing devices. In a preferred embodiment, a network of sensing devices is placed at a perimeter of the worksite, or with a view of the worksite, to monitor areas of the worksite or individual machines. For example, 3D cameras are placed along the fence line of a worksite (or at locations throughout the worksite) to provide overlapping coverage of the entire worksite. The 3D cameras monitor, with up to 360 degrees of coverage, machines operating (e.g., loading, dozing, excavating, leveling, digging, etc.) in the worksite around a targeted machine. The 3D cameras detect if any other machines or objects are within a determined distance of the machine. In a preferred embodiment, the geofence dynamically changes as the machine navigates locations in the worksite. For example, the 3D cameras can communicate with each other to ensure that as the machine moves, the dynamic geofence is maintained at any location in the worksite. In some cases, the origin point (center point) of the geofence is the real-time location (e.g., GPS position or geolocation point) of the machine. Additional details on the dynamic geofence are provided below in relation to FIG. 4-7.

In some embodiment, the alert module 344 is configured to alert a user of an obstacle within the geofence of an operating machine. Alert module 344 can send an alert (e.g., notification) to machine operators, personnel at jobsite, or to the worksite command center, when an object is detected within an unacceptable range from an operating machine at the worksite. In some cases, the alert is a real-time alert requiring action by the user. In other cases, the alert is recorded and stored for later review, such as a safety report. Alert module 344 can rank the level of response to the alert based on the obstacle being human, a machine, or an object. In some examples, the machine powers down or remains stationary for a time threshold based on the level of the alert. In some cases, the user must acknowledge the alert before resuming operation of the machine. Additional details on the alerts are provided below in relation to FIG. 4-7.

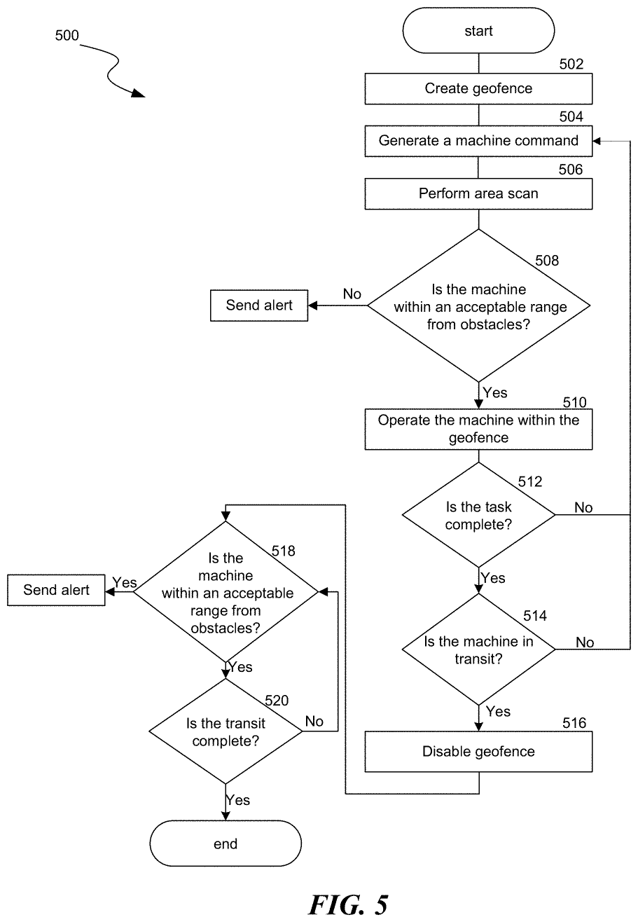

In some embodiments, the machine command module 346 is configured to control the machine remotely. An operator can remotely control a machine from a modular and customized virtual cab. A remote control can provide full machine maneuverability to the operator from a safe distance (e.g., feet or miles), while the machine operates in hazardous environments. A single user can control multiple machines, simultaneously or one at a time, or change jobsite locations from a virtual command cab. The virtual cab can provide an experience to the operator with machine controls and displays similar to those inside an operator's cab of a machine. The operator or other site personal can receive data from sensing devices (e.g., 3D cameras, sensors, satellites, drones, infrared cameras, range finders, geolocation monitors, motion sensors, temperature sensors, vibration or tilt sensors etc.) on the machine and in the worksite. In some cases, the operator receives an alert that the devices require recalibration. The operator can recalibrate the devices remotely or manually. Additional details on the remotely controlled machines are provided below in relation to FIG. 4-5.

Those skilled in the art will appreciate that the components illustrated in FIGS. 1-3 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 4 is a flow diagram illustrating a process 400 used in some implementations for a dynamic geofence. In a preferred embodiment, process 400 is triggered by the machine powering on, a user (e.g., operator) pressing a button on a control device or inputting a command, detected movement in the worksite area, time of day (e.g., when a work shift starts), detected weather conditions, the number of machines in the worksite, type of machines operating, or process 400 is always operating while the machine is in an active worksite.

At step 402, process 400 performs a scan for machines, objects (e.g., fences, rocks, trees, pipes, buildings, etc.) or personnel in the geofence region. Examples of machines are, but not limited to, bulldozers, excavators, trenchers, loaders, backhoes, compactors, graders, feller bunches, graders, wheel tractor scrapers, skid-steer loaders, dump trucks, cranes, telehandlers, pavers, or pile-driving/boring machines.

At step 404, process 400 identifies a machine in the geofence via devices such as (e.g., 3D cameras, sensors, satellites, infrared cameras, range finders, geolocation monitors, motion sensors, temperature sensors. vibration or tilt sensors, etc.). In some cases, the machines have identification, such as serial numbers or RFID tags.

At step 406, process 400 determines if the machine is active via devices similar to those used in step 404. In some cases, process 400 determines if the machine is active by measuring the temperature of the machine, monitoring if the machine has moved for a threshold of time (e.g., every threshold amount of time, such as seconds, minutes, hours, or days), or checking a database to verify if the machine has been assigned to an operator. In some implementations, process 400 determines the machine is inactive and continues to step 402.

At step 408, process 400 determines if the machine is detected within an unacceptable range from obstacles such as other machines, objects, or personnel in the geofence region. In some implementations, the unacceptable range is a predetermined distance within which the machine when operating can cause harm to personnel, machines, or objects. In some cases, process 400 determines the machine is within an acceptable range from other machines, objects, or personnel and continues to step 414.

At step 410, process 400 instructs the machine to remain stationary or power down when the machine is detected within an unacceptable range from other machines, objects, or personnel at the worksite. In some cases, process 400 instructs the machine to power down or remain stationary based on the proximity distance to other machines or objects in the geofence region. In an example, when the machine is a threshold distance (e.g., any distance, such as 50 feet) from a detected machine or object, the machine remains stationary or powers down. The machine can remain stationary or power down for a temporary amount of time (e.g., seconds or minutes) or an extended amount of time (e.g., hours or days) based on the detected machine or object. For example, if another machine drives along the perimeter of the geofence region, the machine remains stationary or powers down temporarily until the other machine has exited the perimeter of the geofence region. In another example, if another machine enters the geofence region, the machine remains stationary or powers down for an extended amount of time until the other machine has exited the perimeter of the geofence region.

In other cases, process 400 instructs the machine to power down or remain stationary, when the machine is detected within an unacceptable range from other machines, objects, or personnel at the worksite, based on the task the machine is performing. In some implementations, the machine performs a task (e.g., loading, dozing, excavating, leveling, digging, etc.) that has severe consequences for failed operations based on the geography of the location of operation. For example, a machine operating in a mineshaft or on the side of a cliff powers down or remains stationary for an extended amount of time when other machines or objects are detected, to ensure the machine is not damaged or destroyed. In some cases, when the presence of a person is detected within the geofence region, process 400 instructs the machine to power down, rather than remaining stationary, as a safety precaution due to detecting a person. Process 400 can instruct the machine to power on once the obstacle is in an acceptable range from the machine.

At step 412, process 400 sends an alert (e.g., notification) to the machine operator, personnel at jobsite, other machine operators, other machines, or to the worksite command center, when the machine is detected within an unacceptable range from obstacles at the worksite. In some cases, the alert is a real-time alert requiring action by the operator. In other cases, the alert is recorded and stored for later review, such as a safety report. Process 400 can rank the level of response to the alert based on the obstacle being human, a machine, or an object. In some examples, the machine powers down if a machine or other device triggers the alert. In other examples, the machine remains powered on and stationary if another machine triggers the alert. A user via a mobile device or via a control on a machine can trigger the alert. For example, a user in the worksite presses a button to alert the operator of their presence or a nearby machine or object.

In some embodiments, process 400 repeats if there are other machines in geofence regions in the worksite until all the machines have been analyzed. Process 400 can access a database to determine if other machines are scheduled to operate during a window of time. In some cases, process 400 determines one or more machines have not been analyzed and continues to steps 402 or 404. In some embodiments, process 400 performs steps 402-412 for the worksite. The worksite can include multiple overlapping geofences, such as a moving/dynamic geofence around a machine can trigger responses within other geofences in the worksite. In some examples, if multiple machines have dynamic geofences while performing tasks in a worksite, the geofences may overlap while the machines operate within the geofence radius of each other. In other examples, when there are geofences around areas in the worksite, the dynamic geofences around a machine may overlap with the stationary geofence. When dynamic geofences overlap, process 400 may instruct the machine or machines to continue operating, power down, or remain stationary.

FIG. 5 is a flow diagram illustrating a process 500 used in some implementations for operating a machine in a dynamic geofence. In a preferred embodiment, process 500 is triggered by the machine powering on, a user (e.g., operator) pressing a button on a control device or inputting a command, detected movement in the worksite area, time of day (e.g., when a work shift starts), detected weather conditions, the number of machines in the worksite, type of machines operating, or process 500 is always operating while the machine is in an active worksite.

In some implementations, the machines are autonomous, semi-autonomous, or remote controlled from a modular and customized virtual cab. A remote control can provide full machine maneuverability to the operator from a safe distance (e.g., feet or miles), while the machine operates in hazardous environments. A single user can control multiple machines, simultaneously or one at a time, or change jobsite locations from a virtual command cab. The virtual cab can provide an experience to the operator with machine controls and displays similar to those inside an operator's cab of a machine. The operator or other site personal can receive data from sensing devices (e.g., 3D cameras, sensors, satellites, drones, infrared cameras, range finders, geolocation monitors, motion sensors, temperature sensors, vibration or tilt sensors etc.) on the machine and in the worksite. In some cases, the operator receives an alert that the devices require recalibration. The operator can recalibrate the devices remotely or manually.

At step 502, process 500 creates/generates a geofence (e.g., a virtual perimeter) around a machine or location at a worksite. In a preferred embodiment, a network of sensing devices is placed at a perimeter of the worksite, or with a view of the worksite, to track individual objects (e.g., machines or persons). The network of sensing devices creates the geofence around areas of the worksite or around individual machines. For example, 3D cameras are placed along the fence line of a worksite (or at locations throughout the worksite) to provide overlapping coverage of the entire worksite. The 3D cameras monitor, with up to 360 degrees of coverage, machines operating (e.g., loading, dozing, excavating, leveling, digging, etc.) in the worksite, to detect if any other machines or objects are within a determined distance of the machine. In a preferred embodiment, the geofence dynamically changes as the machine navigates locations in the worksite. For example, the 3D cameras can interact with each other to ensure that as the machine moves, the dynamic geofence is maintained at any location in the worksite. In some cases, the origin point (center point) of the geofence is the real-time location (e.g., GPS position or geolocation point) of the machine.

The dimensions of the geofence can dynamically change based on the type of machine, time of day, weather conditions, terrain conditions, experience level of the operator, time of personnel shift change at the worksite, number of personnel or machines at the worksite, or the task (e.g., loading, dozing, excavating, leveling, digging, etc.) the machine is performing. In an example, the dimensions of the geofence increase when the weather conditions result in low visibility for the operator of the machine. In another example, the dimensions of the geofence decrease when the operator has a high level of experience (e.g., years of experience) operating the machine. In another example, the dimensions of the geofence decrease based on the task of the machine (e.g., so a machine can operate near another machine without an alert, such as, a loader filling up a dump truck). The dimensions of the geofence can dynamically adjust for vertical/height/airspace requirements depending on nearby equipment (e.g., the geofence includes a region, such as 10 feet above the operating machinery to a ceiling height of 1,000 feet, in order to prevent a crane, drone, helicopter, or other object from intruding overhead).

In some implementations, the geofence is generated to cover the work area based on a semi-autonomous command assigned to the machine. Each type of machine has a geofence with dimensions based on the type of machine or the task the machine is performing. In an example, the geofence around machine digging has smaller dimensions than the geofence around a machine leveling, due to the leveling machine traveling more during the task. In another example, the dimensions around a machine is based on the type of machine due to the visibility of the operator, the maneuverability of the machine, or the type of sensors on the machine (e.g., motion sensors, proximity distance sensors, etc.). The dimensions of the geofence can change when the machine is autonomous, semi-autonomous, or remote controlled. For example, when the machine is autonomous, or semi-autonomous the dimensions of the geofence are larger than the dimensions of a geofence around a machine with a human operator. The operator of a remote-controlled machine using 3D cameras and sensor devices, may have greater visibility of the area surrounding the machine than an operator siting in the cab of the machine. For example, the dimension of a geofence around a remote-controlled machine, are smaller than the dimensions around machine operated by an operator sitting in the cab.

At step 504, process 500 generates a machine command to perform a task (e.g., loading, dozing, excavating, leveling, digging, etc.) at the worksite. At step 506, process 500 performs an area scan with the sensing devices for obstacles, such as other machines, objects or personnel in the worksite, while the machine is operating. Process 500 can identify human versus non-human objects (e.g., personnel vs a machine), or wildlife. In some cases, process 500 identifies authorized versus unauthorized objects. In an example, personnel with personal protective equipment (PPE) are authorized in the geofence but personnel without PPE are not authorized. In another example, a truck with a scheduled delivery is authorized in the geofence region but an unscheduled delivery is not authorized. Process 500 can identify dangerous objects (e.g., fires, oil spills, smoke, etc.) for immediate response or graduated response when less dangerous (e.g., exhaust smoke from a machine). Process 500 can identify objects not within but coming near to the geofence region as the machine operates. For example, process 500 identifies a delivery truck approaching the geofence region. In some cases, process 500 identifies objects based on a pre-assigned priority (e.g., a supervisor human entering the geofence may cause a response different than a new employee entering the geofence). In other cases, process 500 identifies unexpected or changing objects (e.g., a new pile of rocks indicates subsiding hillside or an unscheduled delivery of rocks).

At step 508, process 500 determines if the machine is within an acceptable range from the obstacles at the worksite. In some cases, process 500 detects the machine is within an unacceptable range from obstacles and sends an alert (e.g., sound-alert or flashing color icons) to the machine operator, other machines, other machine operators, site personnel, or to a command center. The alert can notify the recipient about the proximity of the obstacle to the geofence around the machine. The operator can receive safety alerts if machines, objects, or personnel intrude or come within a proximity of the geofence around the machine. In some cases, the alert is a real-time alert requiring action by the operator. In other cases, the alert is recorded and stored for later review, such within as a safety report.

Process 500 ranks the level of response to the alert based on the identified obstacle at step 506. For example, an identified human causes a higher level of response than a non-human object. The machine power down or remains stationary based on the level of alert. In an example, a detected human object causes the machine to shut down. In another example, the machine remains stationary if another machine is detected in the geofence region but exits within a time threshold. In another example, the alert is ignored if the obstacle is involved in the task, such as the geofence on a loader detects the dump truck being loaded with dirt. In another example, a detected emergency, such as a fire, causes the machine to power down. Process 500 can require the operator to acknowledge (e.g., press a button or control) the alert before continuing to operate the machine. For example, if another machine is operating on the perimeter of the geofence of a machine, the operator must acknowledge the presence of the other machine before continuing operation.

At step 510, process 500 operates the machine within the geofence at the worksite. At step 512, process 500 can determine if the machine has completed the task. The operator can determine if the task is complete. In some cases, process 500 determines the task is not complete and continues to step 504. At step 514, process 500 can determine if the machine is in transit from a task location. In some cases, process 500 determines the machine is not in transit and continues to step 504.

At step 516, process 500 disables the geofence or reduces the dimensions of the geofence region for a machine, when the machine is in transit between locations at the worksite. For example, process 500 can disable the geofence by turning off the sensing devices monitoring the machine performing the task. In some cases, process 500 can replace the disabled geofence with a new geofence region for the transit of the machine. In other cases, the dimensions of the current geofence are reduced to allow the operator to transit to another location without constant alerts. The geofence region can be the transit path for the machine. The disablement can be temporary, of high or low priority, or a virtual disablement (e.g., the geofence has no sensor view to a certain limited part of the worksite—a culvert—but presumes the fence encompasses the area all the same).

Process 500 can notify all the operators at a worksite, when a geofence is disabled or when the dimensions of a geofence are adjusted for a machine. For example, process 500 sends an alert to operators of nearby machines that the machine is in transit. In some implementations, process 500 expands the geofence of the machine during transit (e.g., to include another geofence during transit). Process 500 can use external sensors (e.g., audible or visible light) to demarcate the geofence or provide a temporary or audible description of the geofence boundaries to the operator or nearby operators. In some cases, process 500 sends an alert to the operator when the geofences fails (e.g., one or more sensing devices fails, is unable to communicate with other sensors, or is out of calibration). When the geofence fails, the operator can send an alert to other operators about the failure before requesting maintenance on the geofence.

At step 518, process 500 can determine if the machine is within an acceptable range from obstacles at the worksite while in transit. In some cases, process 500 detects the machine is within an unacceptable range from obstacles and sends an alert (e.g., similar to the alert described at step 508). At step 520, process 500 can determine if the transit of the machine is complete. Process 500 can continue to step 518 until the transit is complete.

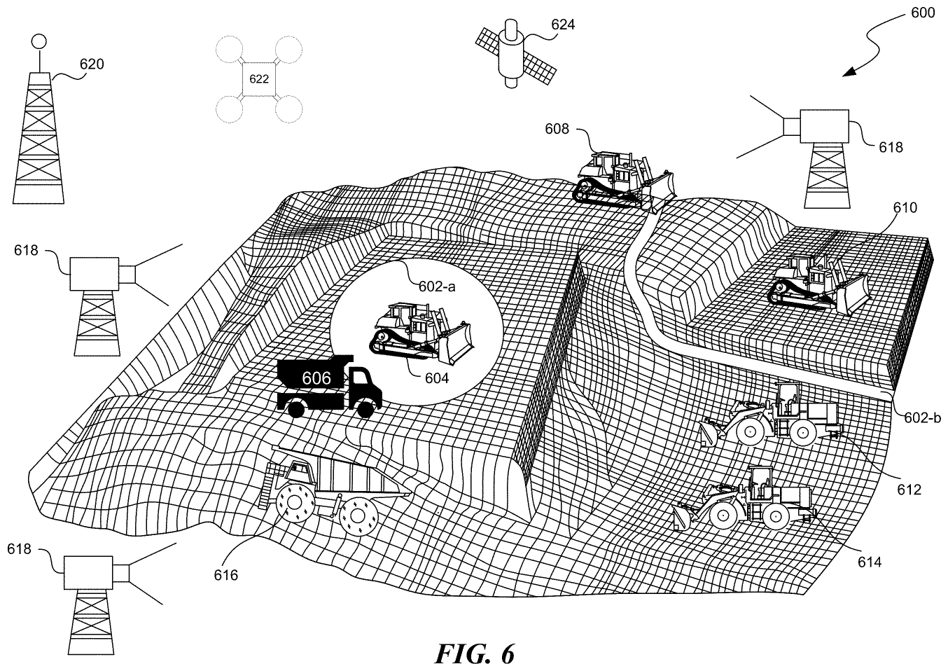

FIG. 6 is a conceptual diagram illustrating an example 600 of a worksite environment with a dynamic geofence. Example 600 illustrates, machines 604, 606, 608, 610, 612, 614, and 616, operating at a worksite. In a preferred embodiment, a network of sensing devices (e.g., camera 618, communicating tower 620, drone 622, and satellite 624) is placed at a perimeter of the worksite, or with a view of the worksite, to track objects (e.g., machines 604, 606, 608, 610, 612, 614, and 616). The network of sensing devices creates the geofence around areas of the worksite (as shown with geofence 602-b) or around individual machines (as shown with geofence 602-a). For example, 3D cameras, such as cameras 618, are placed along the perimeter of a worksite (or at locations throughout the worksite) to provide overlapping coverage of the entire worksite. The 3D cameras monitor, with up to 360 degrees of coverage, machines operating (e.g., loading, dozing, excavating, leveling, digging, etc.) in the worksite, to detect if any other machines or objects are within a determined distance of the machine. In a preferred embodiment, the geofence 602-a dynamically changes as the machine 604 navigates locations in the worksite. For example, the 3D cameras can interact with each other to ensure that as the machine 604 moves, the dynamic geofence 602-a is maintained at any location in the worksite. In some cases, the origin point (center point) of the geofence 602-a is the real-time location (e.g., GPS position or geolocation point) of the machine 604.

The geofence 602-a can detect obstacles that are within a proximity (e.g., any distance such as 30 feet) of machine 604. For example, when machine 606 triggers the dynamic geofence 602-a, an alert is sent to the operator of machine 604, indicating machine 606 is within the geofence 602-a. In some cases, the operator of machine 606, supervisors, operators of machines in the worksite, or worksite personnel, also receive the alert. Notifications can be sent to backend systems to record all alerts for review. The notifications/alerts can be based upon orientation or other operating characteristics of the intruder machine 606, operating machine 604 or other detected machines. For example, machine 606 is working on a task with machine 604, so notifications are unnecessary or of low priority, since machine 606 will frequently trigger an alert with entering geofence 602-a.

In an embodiment, geofence 602-a is based upon the operating characteristics of machine 604 (e.g., machine 604 requires a level operating surface). Geofence 602-a can be dynamically adjusted based on the type of machine, the task of the machine, or the operating terrain of the machine. For example, if machine 604 is moving piles of rocks in uneven terrain, geofence 602-a is adjusted to not send an alert every time it detects a pile of rocks.

In some implementations, geofence 602-b is based on the geography or specific geographic features of the worksite. Geofence 602-b can dynamically adjust as the geographic features of the terrain adjust. For example, as machine 610 digs out a hill or expands out a level surface of the terrain, the geofence 602-b adjusts to include the new geographic features of the terrain. The geofence 602-b can detect machine 608 approaching the task area of machine 610. For example, when machine 608 triggers the dynamic geofence 602-b, an alert is sent to the operator of machine 610, indicating machine 608 has intruded the geofence 602-b. In some cases, the operator of machine 608, supervisors, operators of machines in the worksite, or worksite personnel, also receive the alert.

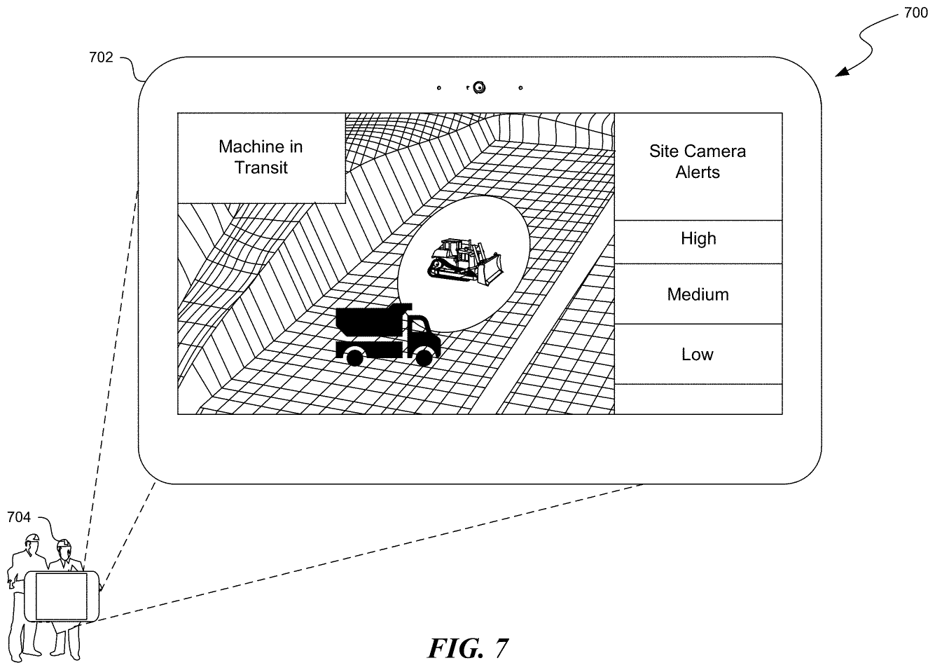

FIG. 7 is a conceptual diagram illustrating an example 700 of a worksite environment with a dynamic geofence displayed on a device. In some implementations, the geofence around a machine or location detects obstacles and sends an alert (e.g., notification, sound-alert or flashing color icons) to user 704. User 704 can be a supervisor at the worksite, the operator of the intruder machine, the operator of the machine with the geofence, other machine operators at the worksite, or worksite personnel.

The alert can notify the user 704 about the nearby machine, object, or personnel to the geofence. The user 704 can view the alert, notification message, the live video feed, sensor data, or any information related to the incident on device 702. The alerts are ranked by levels (e.g., low, medium, or high) based on the obstacle detected. In an example, the alert has a high level based on the detected object being a human. In another example, the alert is a real-time alert requiring action by user 702. In another example, the alert is recorded and stored for later review such as a safety report or meeting. In some cases, when a notification is unobserved or ignored by user 702, there is an escalation of notifications throughout the worksite. An unobserved notification potentially leads to a gradual notification expansion to other geofenced equipment or personnel at the worksite). For example, an intrusion within the geofence surrounding a rock crushing machine that is ignored, will also expand to include the machines/dump trucks emptying materials into the rock crusher).

### INDUSTRIAL APPLICABILITY

The systems and methods described herein can implement a dynamic geofence in a worksite environment. In some implementations, devices (e.g., 3D cameras, sensors, satellites, infrared cameras, range finders, geolocation monitors, etc.) monitor a worksite environment from positions inside or outside the worksite. In some cases, the devices are placed on the machines to monitor the worksite and automatically create a geofence around a machine as it operates (e.g., loading, dozing, excavating, leveling, digging, etc.). The geofence can dynamically change as the machine navigates locations in the worksite. Operators or site personnel can receive a safety alert (e.g., sound-alert or flashing color icons) regarding the proximity of a person, machine, or object to the geofence around the machine.

In some implementations, the machines are autonomous, semi-autonomous, or remote controlled from a modular and customized virtual cab. A remote control can provide full machine maneuverability to the operator from a safe distance (e.g., feet or miles), while the machine operates in hazardous environments. A single user can control multiple machines, simultaneously or one at a time, or change jobsite location without traveling from the virtual cab in the office. The virtual cab can provide an experience to the operator with machine controls and displays similar to those inside an operator's cab of a machine. In some cases, the geofence is automatically generated to cover the work area based on the semi-autonomous command assigned to the machine. The operator or other site personal can receive live video feed of the jobsite and all safety alerts if objects or personnel intrude or come within a proximity of the geofence around the machine. The present systems and methods can be implemented to manage, control, and communicate multiple industrial machines, vehicles and/or other suitable devices such as mining machines, trucks, corporate fleets, etc.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g. “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A computing system comprising:
one or more processors; and
one or more memories storing instructions that, when executed by the one or more processor, cause the computing system to perform a process comprising:
creating a geofence around a machine operating within a worksite environment, wherein the geofence dynamically changes while the machine moves;
generating a machine command to control the machine remotely from a virtual control location;
performing a scan of the worksite environment around the machine;
determining obstacles in the worksite environment are outside the geofence of the machine; and
operating the machine within the geofence from the virtual control location.

2. The computing system of claim 1, wherein the process further comprises:
determining the machine has completed a task;
determining the machine is in transit based on the completed task; and
disabling the geofence as the machine exits the worksite environment.

3. The computing system of claim 1, wherein the process further comprises:
in response to determining the obstacles in the worksite environment are within the geofence of the machine:
receiving an alert regarding the obstacles in the worksite environment.

4. The computing system of claim 1, wherein the process further comprises:
identifying the machine in the worksite environment;
determining the machine is operating while the obstacles are within the geofence; and
instructing the machine to shut down.

5. The computing system of claim 1, wherein the machine is an origin point for the geofence.

6. The computing system of claim 1, wherein the virtual control location is a remote-control center to operate autonomous or unmanned machines.

7. The computing system of claim 1, wherein the process further comprises:
determining parameters of the geofence based on a threshold distance the machine operates from obstacles.

8. An apparatus for automated geofencing on machines, comprising:
a memory;
one or more processors electronically coupled to the memory and configured for:
creating a geofence around a machine operating within a worksite environment, wherein the geofence dynamically changes while the machine moves;
generating a machine command to control the machine remotely from a virtual control location;
performing a scan of the worksite environment around the machine;
determining obstacles in the worksite environment are outside the geofence of the machine; and
operating the machine within the geofence from the virtual control location.

9. The apparatus of claim 8, wherein the one or more processors are further configured for:
determining the machine has completed a task;
determining the machine is in transit based on the completed task; and
disabling the geofence as the machine exits the worksite environment.

10. The apparatus of claim 8, wherein the one or more processors are further configured for:
in response to determining the obstacles in the worksite environment are within the geofence of the machine:
receiving an alert regarding the obstacles in the worksite environment.

11. The apparatus of claim 8, wherein the one or more processors are further configured for:
identifying the machine in the worksite environment;
determining the machine is operating while the obstacles are within the geofence; and
instructing the machine to shut down.

12. The apparatus of claim 8, wherein the machine is an origin point for the geofence.

13. The apparatus of claim 8, wherein the virtual control location is a remote-control center to operate autonomous or unmanned machines.

14. The apparatus of claim 8, wherein the one or more processors are further configured for:
determining parameters of the geofence based on a threshold distance the machine operates from obstacles.

15. A method for automated geofencing on machines, the method comprising:
creating a geofence around a machine operating within a worksite environment, wherein the geofence dynamically changes while the machine moves;
generating a machine command to control the machine remotely from a virtual control location;
performing a scan of the worksite environment around the machine;
determining obstacles in the worksite environment are outside the geofence of the machine; and
operating the machine within the geofence from the virtual control location.

16. The method of claim 15, further comprises:
determining the machine has completed a task;
determining the machine is in transit based on the completed task; and
disabling the geofence as the machine exits the worksite environment.

17. The method of claim 15, further comprises:
in response to determining the obstacles in the worksite environment are within the geofence of the machine:
receiving an alert regarding the obstacles in the worksite environment.

18. The method of claim 15, further comprises:
identifying the machine in the worksite environment;
determining the machine is operating while the obstacles are within the geofence; and
instructing the machine to shut down.

19. The method of claim 15, wherein the machine is an origin point for the geofence.

20. The method of claim 15, wherein the virtual control location is a remote-control center to operate autonomous or unmanned machines.
